(19) United States
(12) Patent Application Publication
(10) Pub. No.: US 2007/0107806 A1
(43) Pub. Date: May 17, 2007

(54) Ezee-feed

(76) Inventor: Lee A. Jesberger, Sewell, NJ (US)

Correspondence Address: MICHAEL RIES, 318 PARKER PLACE, OSWEGO, IL, 60543, US

(21) Appl. No.: 11/600,463

(22) Filed: Nov. 16, 2006

Related U.S. Application Data
(60) Provisional application No. 60/737,414, filed on Nov. 17, 2005.

(51) Int. Cl. B25H 1/00; B23Q 3/00

(52) U.S. Cl. 144/286.5; 269/296

(57) ABSTRACT

An infeed/outfeed attachment for facilitating the processing of sheet goods through a processing device. The infeed/outfeed attachment may have a support frame, a plurality of coplanar ball rollers, a track, an engagement section in sliding engagement with the track, a cylindrical roller for reducing friction during loading and unloading of the sheet goods, vertically adjustable legs, and a hinge allowing the attachment to fold flat for easy storage. Track may have a groove. The groove and the engagement section may have T-shaped cross-sections. The engagement section having a T-shaped cross-section may have an L-shaped member, a washer, an intermediate member, a threaded bolt and a nut. Also, a method of attaching the infeed/outfeed attachment to the processing device, the processing device having a table and a beam attached to the table with a plurality of bolts.

This application claims the benefit of U.S. Provisional Patent Application Ser. No. 60/737,414, filed Nov. 17, 2005.

### TECHNICAL FIELD AND BACKGROUND

The present invention generally relates to the field of processing equipment. Specifically, the present invention relates to attachments for facilitating the processing of materials through a processing device. More specifically, the present invention relates to a table attachment for facilitating the processing of sheet goods, such as plywood, through a processing device, such as a table saw or router.

There are many devices for processing sheet goods. There are approximately 6 million table saws or related machines currently in use in the United States, and approximately 80,000 units are sold each year. However, with known processing devices, it is often the case that the devices are not particularly suited for prevention of back injuries to the user or preventing damage to the sheet goods before, during and after processing. It is often difficult for one person to efficiently and effectively process a material, such as a large sheet of plywood or long piece of lumber, through a processing device, such as a table saw or router. In some cases, an individual piece of material may weigh nearly 100 pounds. When a particular piece of material is heavy, it may be difficult to load and unload the material. Also, it may be difficult to accurately position and move the material through the processing device. For large pieces of material, a worker might not be able to see around the material when loading the material onto the processing device. Often, a worker will load the material, without being able to see, by bumping the material into the processing device, resulting in damage to the material or the processing device itself. Also, the awkwardness of the known loading procedure often leads to back injury. Further, when loading a large piece of material, such as a piece of material that is eight feet long, a single worker will be positioned far away from the cutting point of the processing device. One method for a single worker to process a piece of material is to apply force to the material against the rip fence along the full length of the material while guiding the material through the processing device. Often, this procedure results in the inaccurate processing of the material.

The present invention overcomes the above-referenced problems related to single user operation of processing devices, particularly regarding the processing of sheet goods.

### BRIEF DESCRIPTION OF THE DRAWINGS

The present invention will be described by way of exemplary -embodiments, but not limitations, illustrated in the accompanying drawings in which like references denote similar elements, and in which:

FIG. 1 is a perspective side view of an embodiment of an infeed/outfeed table attachment;

FIG. 2 is a perspective side view of another embodiment of an infeed/outfeed table attachment attached to a table saw;

FIG. 3 is a perspective side view of yet another embodiment of an infeed/outfeed table attachment attached to a router;

FIG. 4 is a perspective side view of infeed/outfeed table attachment in a folded position;

FIG. 5 is a perspective side view of a processing device/worktable and a rip fence guide;

FIG. 6 is a perspective end view of the processing device/worktable and the rip fence guide;

FIG. 7 is a perspective bottom view of the processing device/worktable and the rip fence guide;

FIG. 8 is a perspective bottom view of the processing device/worktable, the rip fence guide, and an angle bracket attached to the rip fence guide;

FIG. 9 is a perspective side view of five angle brackets attached to the rip fence guide;

FIG. 10 is a perspective side view of a track being attached to the angle brackets, where holes are drilled in the track and angle brackets using a handheld drill;

FIG. 11 is a perspective end view of a horizontal movement device; and

FIG. 12 is a perspective side view of the processing device/worktable, the rip fence guide, the angle brackets, and the horizontal movement device.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation. The phrase in one embodiment is used repeatedly. The phrase generally does not refer to the same embodiment, however, it may. The terms comprising, having and including are synonymous, unless the context dictates otherwise.

The present invention is directed to a removable, portable metal infeed/outfeed extension table attachment designed for, but not limited to woodworking machinery. Infeed/outfeed is defined also as just the term feed. So when the term feed is used it could mean infeed only or out feed only or any combination of infeed outfeed. The table attachment is particularly well suited for use and operation by one operator, but may, of course, be used by multiple workers. The table attachment allows one person to load sheet goods, for example, plywood, solid surface goods and the like, onto a processing device. The table attachment is particularly well suited for heavy sheet materials weighing as much as 100 pounds and more but any weight sheet material will be easy to move and align with my present invention. The table attachment may be provided in any suitable length or width and may be adapted for use with any type of processing device. The table attachment may be constructed of metal tube framework and may be welded or bolted together. As described in greater detail below, the table attachment may be attached perpendicularly to the existing front, side and/or rear of a processing device. The table attachment may have a frame with folding metal legs for support. The frame may have a series of cross members attached perpendicularly to the frame, onto which may be mounted a series of ball rollers or transfer ball glides. The ball rollers may be provided flush or coplanar with the work surface thus enabling large or awkward work pieces to be safely and accurately guided through the cutting or machining process. The left and/or right sides of the table attachment may have a long ball bearing roller to permit easy loading of sheet goods onto and off of the table attachment. The first cross member may be provided far enough from the rail of the processing device so as not to interfere with an existing rip fence commonly found on table saws. The legs of the table attachment may be height adjustable to allow for uneven flooring and to permit a universal fit to various types of common machines found in workshops. The table attachment may be attached to the processing device by means of a rail or track, which is mounted to any side of the machine, and which allows for quick, secure and lockable placement of the table attachment with respect to the processing device. The mounting rail or track may also be available separately and in various lengths to permit one table attachment to be interchangeably used with multiple processing devices.

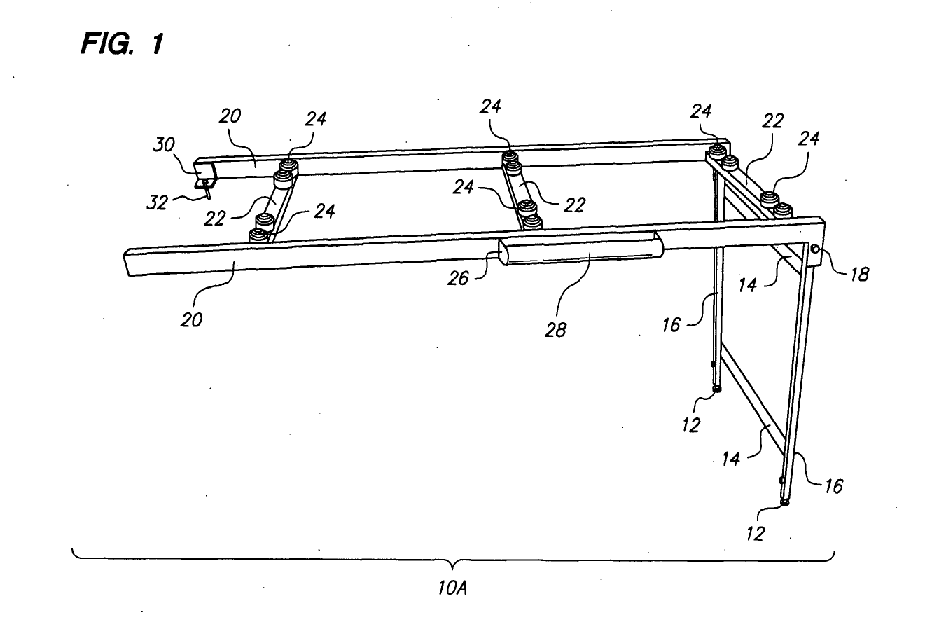

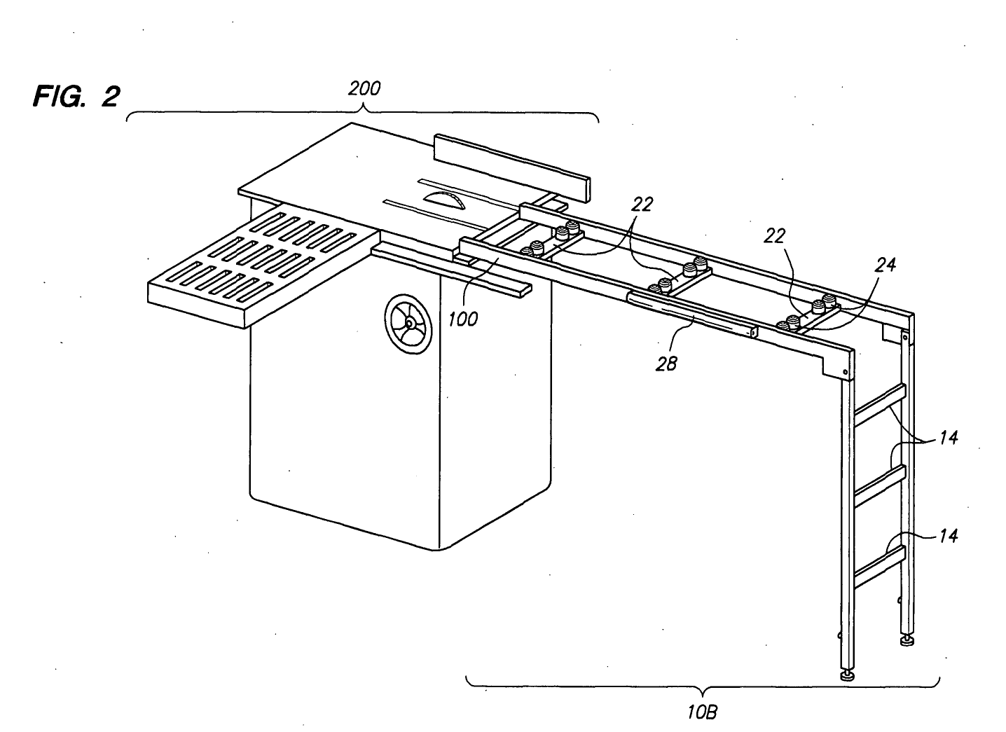

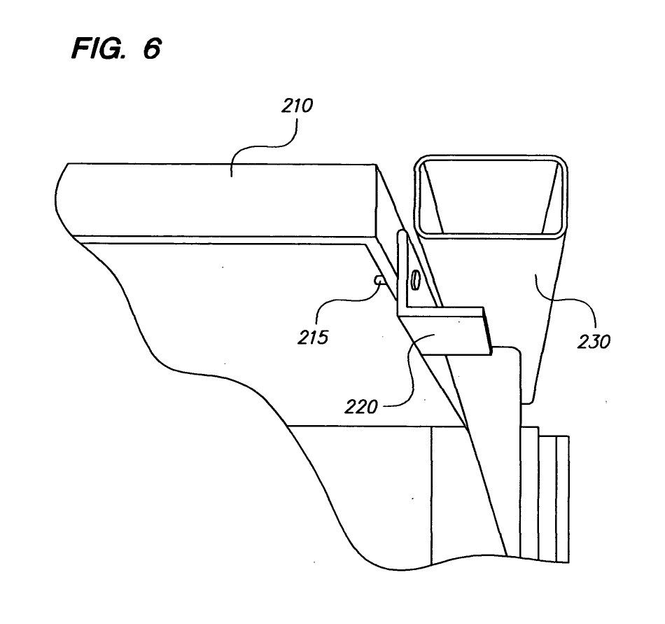

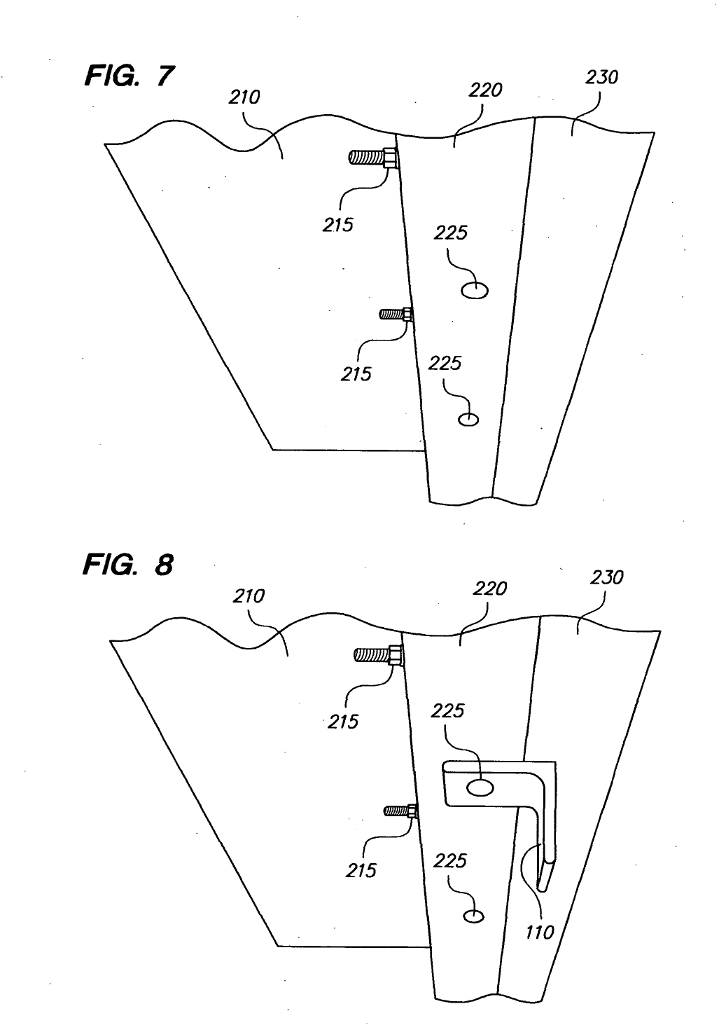

Referring now to FIG. 1, in one embodiment of the present invention, an infeed/outfeed table attachment 10A for processing an object through a processing device/worktable 200 (shown, for example, in FIGS. 2, 3 and 5-12) is provided with a support frame. The object may be a material such as plywood sheet goods, PVC sheet goods, lumber, solid surface goods, composite materials or any material that requires processing through a processing device. The processing device may be a machine such as a saw, a router, a shaper or any other device for processing plywood sheet goods, PVC sheet goods, lumber, composite materials or any suitable material. The processing device may be mounted on or used in association with a worktable.

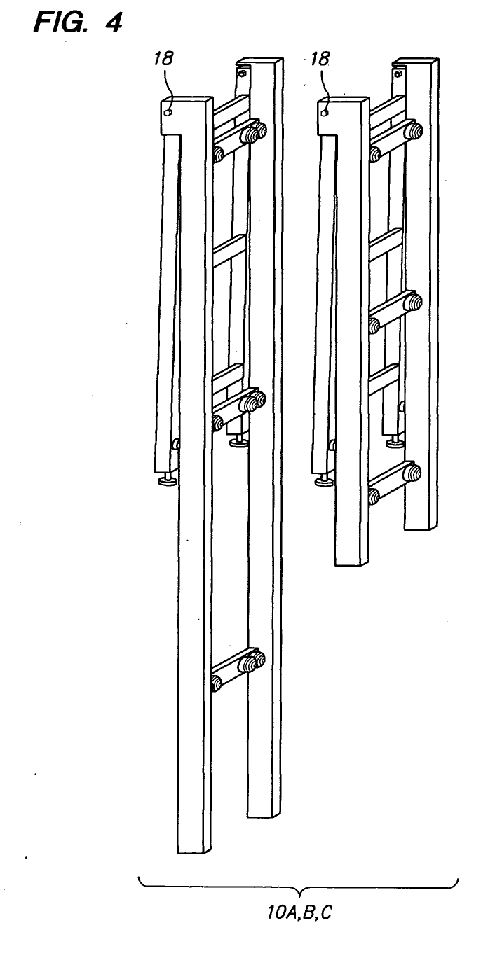

The support frame may comprise a generally vertical portion and a generally horizontal portion, joined together with a hinge device 18 that permits the table attachment 10A to be folded into a flat position, as shown, for example, in FIG. 4. The hinge device 18 may be provided with a lock nut that may be tightened so that the legs do not open and close quickly, thus reducing the chance of crushing the fingers of the user of the device. The vertical portion may comprise vertically adjustable leveling feet 12, vertical support members 16, and horizontal support members 14 provided between the vertical support members 16. The horizontal portion may comprise side support members 20, central support members 22 provided between the side support members 20, and mounting brackets 30. The side support members 20 may be L-shaped on one end, and the end having the L-shaped end may comprise the hinge device 18 and connection to the vertical portion. The ends of side support members 20 may be capped with end caps (not shown). The end caps may be made of plastic, or any other suitable material.

The table attachment 10A may be attached to the processing device using any suitable means. For example, mounting brackets 30 may be generally L-shaped brackets (when viewed in a cross-section through the side of the bracket) that connect a vertical inside surface of the side support members 20 with a horizontal upper surface of sliding mounting brackets 140, to be described in greater detail below. The mounting brackets 30, 140 may be attached to each other using any suitable means, such as use of a nut and bolt connection 32 through corresponding connecting holes formed in the mounting brackets 30, 140.

One or more devices for generally horizontal movement of the material may be mounted to the table attachment 10A. For example, the device for horizontal movement of the material may comprise a plurality of ball rollers 24 mounted to the top side of each of the central support members 22. For example, four pair of ball rollers 24 may be attached to the top side of each of the central support members 22. It is noted that any suitable number of ball rollers 24 may be provided in any suitable position. The ball rollers 24 may be provided in the same plane to permit smooth handling of the material. Where the processing device provides a generally horizontal working surface, the plane for the table attachment 10A is also desirably generally horizontal. The ball rollers 24 are particularly suited for sheet goods such as plywood. The ball rollers 24 may be 1″ diameter-balls, each supported by several dozen smaller ball bearings. In one embodiment, there are 80 smaller ball bearings,for each roller 24. The ball rollers 24 permit a worker to move a sheet material in any desired direction and with little effort.

Also, for example, the device for horizontal movement of the material may comprise a mounting bracket 26 attached to one or both sides of the side support members 20. The mounting bracket 26 may be adapted to support both ends of a cylindrical roller 28. The cylindrical roller 28 spins about an axis and permits lateral movement of the material with respect to the processing device. The cylindrical roller 28 is particularly suited for sheet goods such as plywood. By pivoting the material to be processed on the cylindrical roller 28, the cylindrical roller 28 may effectively reduce the total weight of the material to be processed by fifty percent, thus making it easier to load and unload the material. Once the sheet material is pivoted against the roller 28, a worker may push the material onto the device with less effort.

Using the present invention configured with the components described herein, a worker is able to easily load and unload materials onto and off of the processing device. After loading the material, the worker no longer needs to support the full weight of the material. Also, the rollers permit movement of the material with less effort. Rather than having a situation where the material is resting on the upper surface of the processing device itself, the material is at least partially supported by the table attachment.

FIG. 2 as in one embodiment of the present invention, shown is an infeed/outfeed table attachment 10B having three horizontal support members 14, three central support members 22, and a cylindrical roller 28. In this embodiment, each of the four central support members 22 shown in FIG. 2 has two pair of ball rollers 24. Also shown is attachment of the table attachment 10B to a processing device/worktable 200 (equipped with a table saw) via a horizontal movement device 100. Details of the attachment of the table attachment 10B to the horizontal movement device 100 of the processing device/worktable 200 are provided below.

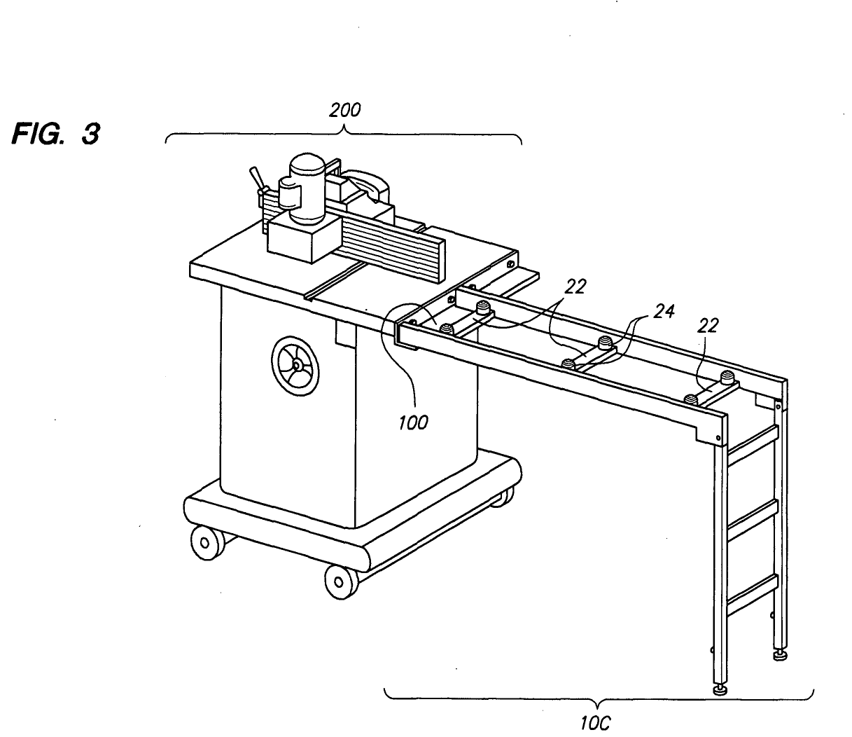

FIG. 3 as in one embodiment of the present invention, shown is an infeed/outfeed table attachment 10C has three central support members 22, and no cylindrical roller 28. In this embodiment, each of the three central support members 22 shown in FIG. 3 has a pair of ball rollers 24. Also shown is attachment of the table attachment 10C to a processing device/worktable 200 (equipped with a router, jig saw, or the like) via a horizontal movement device 100. Details of the attachment of the table attachment 10C to the horizontal movement device 100 of the processing device/worktable 200 are provided below.

FIG. 4 shows two exemplary table attachments 10A/10B/10C, each folded into a flat position, as shown, for example, in FIG. 4. The generally vertical portion and the generally horizontal portion of each table attachment 10A/10B/10C are foldable due to the hinge device 18. In the folded, flat position, the table attachment 10A/10B/10C may be hung from a suitable load-bearing vertical surface such as a storage cabinet or wall (not shown). This feature makes the table attachment 10A/10B/10C easy to store.

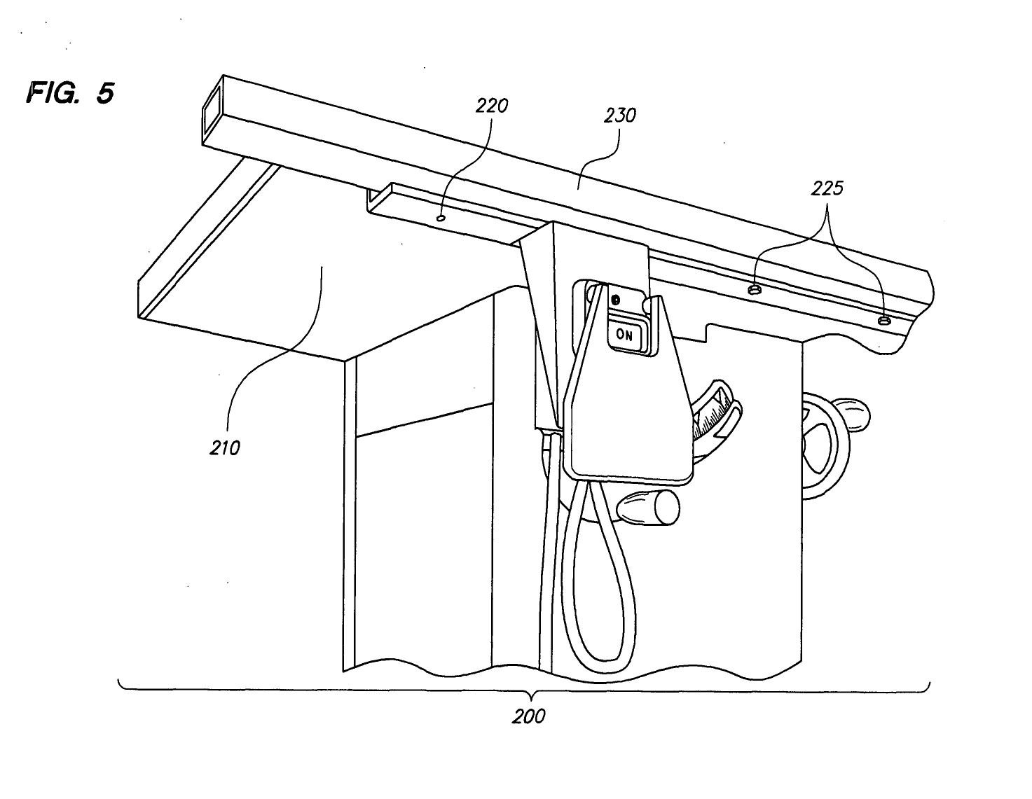

FIGS. 5-7 show a standard connection between a processing device/worktable 200 and a rip fence guide. The rip fence guide typically includes a support bracket 220 and a box beam 230. On the underside of the rip fence guide, fastening bolts 225 are provided for fastening the box beam 230 to the support bracket 220. The support bracket 220 is attached to a working surface 210 of the processing device/worktable 200 using fasteners 215. The support bracket 220 may be L-shaped, where the vertical portion of the bracket 220 is attached to the working surface 210 of the processing device/worktable 200 and where the horizontal portion is attached to the box beam 230. The box beam 230 made be made of steel or any other suitable material.

As shown in FIG. 8, in order to attach the table attachment 10A/10B/10C of the present invention to a processing device/worktable 200, angle brackets 110 are attached to the bottom of support bracket 220 using a plurality of fastening bolts 225. Each angle bracket 110 is provided with a hole adapted to receive fastening bolts 225. One at a time, a user removes the existing fastening bolts, and the angle bracket 110 is attached to the bottom of the support bracket 220 with fastening bolts 225. The angle brackets 110 may be formed from aluminum or any other suitable material. The fastening bolts 225 may be longer than the existing fastening bolts. For example, ¼×20×1 inch bolts may be used for the fastening bolts 225, which generally provides a sufficient length for proper connection of each angle bracket 110 to the support bracket 220.

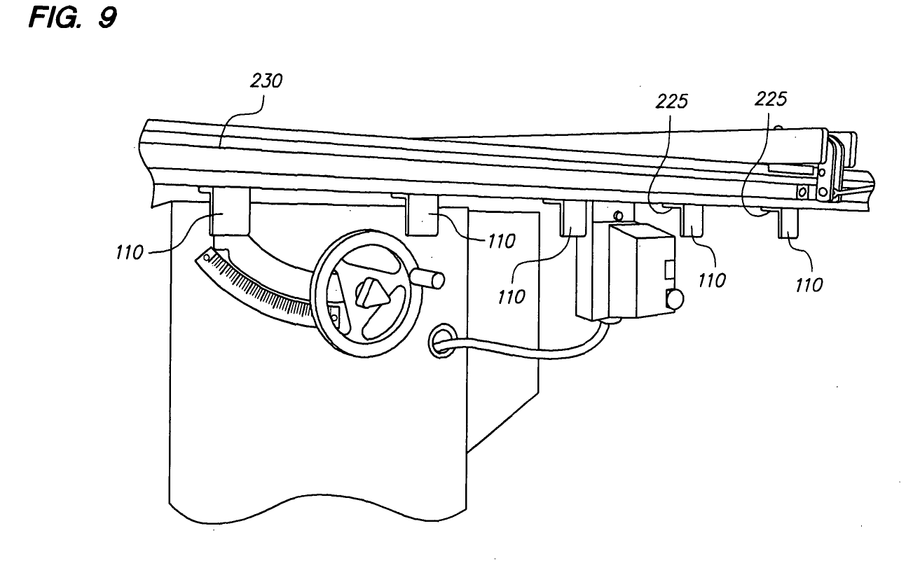

Any suitable number of angle brackets 110 may be attached to the support bracket 220. For example, as shown in FIG. 9, five angle brackets 110 are attached at generally equally spaced intervals.

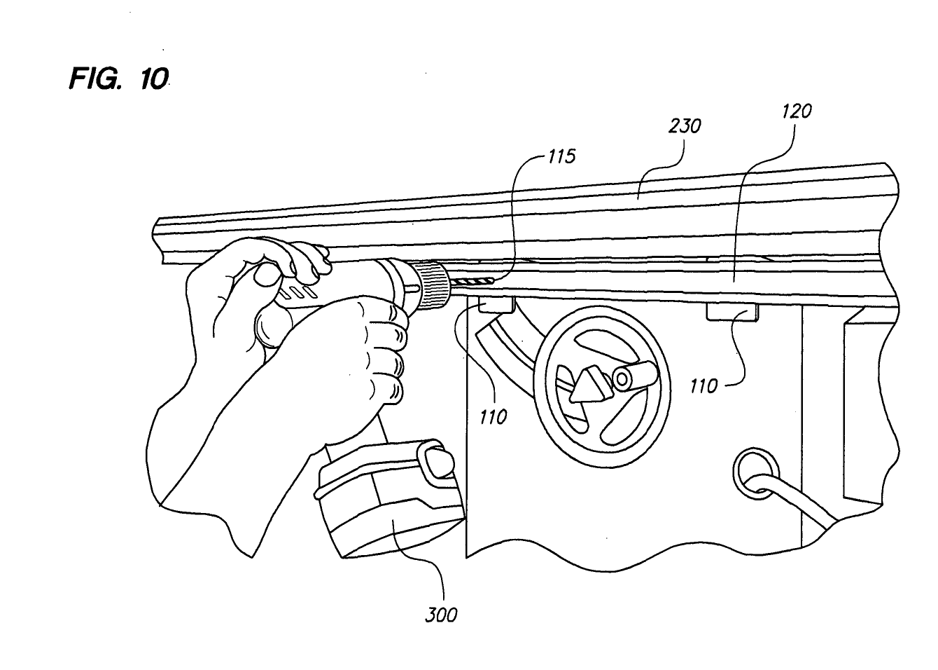

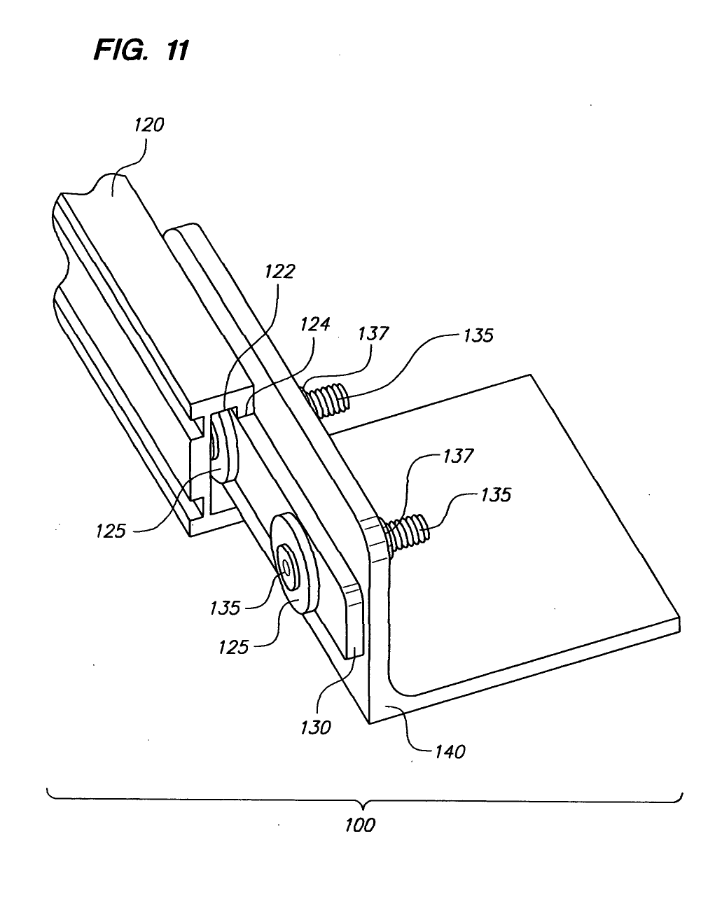

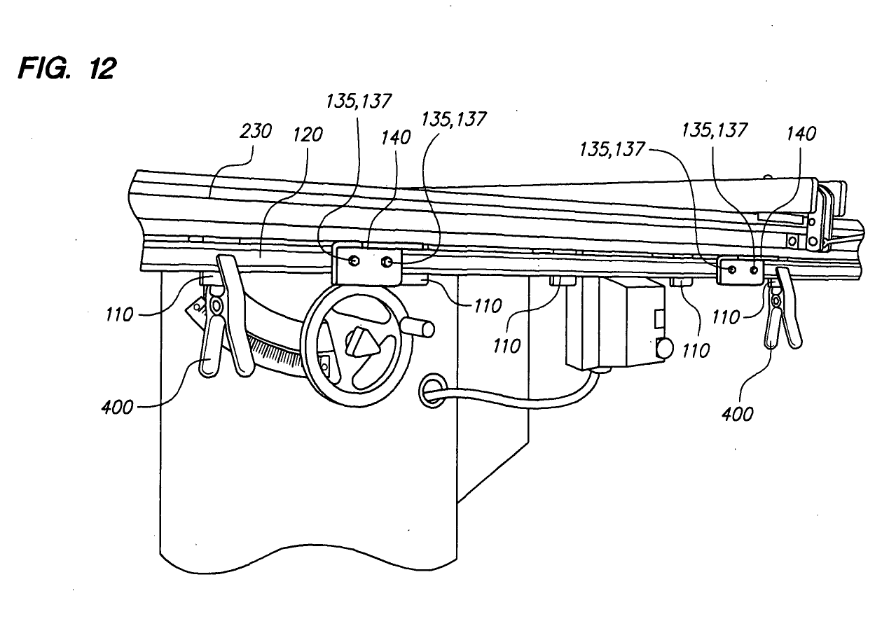

Once the angle brackets 110 are attached to the support bracket 220, as shown, for example, in FIG. 10, a T-track 120 is attached to the angle brackets 110. Temporary clamps 400 (shown in FIG. 12) are used to temporarily secure the T-track 120 to the angle brackets 110. The angle brackets 110 are, in one embodiment, about 1/16″ below the rip fence box beam 230. A piece of laminate or thin cardboard may be used as a shim. The end of the T-track 120 may be provided so as to be even with the end of the processing device/worktable 200. The T-track 120 may be attached to each of the angle brackets 110 with a pair of 10-24 screws 115 with locknuts and washers for each angle bracket 110. A hole may be drilled into T-track 120 using a handheld drill 300 and appropriately sized drill bit. The head of each screw 115 is countersunk into the inside of the T-track 120 so as not to interfere with the operation of the T-track 120 with respect to sliding mounting brackets 140, described in greater detail below.

Either before of after attachment of the T-track 120 to the angle brackets 110, as shown in FIG. 11, a plurality of sliding members 140 are placed into sliding engagement with the T-track 120. The T-track 120 has a large groove 122 adapted to receive washers 125 in sliding engagement. The T-track 120 also has a lip 124 adapted to receive flat section 130 in sliding engagement. The outer diameter of washers 125 is larger than the vertical height of the flat section 130. As such, the combination of the washers 125 and flat section 130 create a T-shape, which fits into sliding engagement with the T-shaped slot formed by large and small groove 122 and the lip 124, respectively. A bolt 135 may be provided to attach the washer 125 and the flat section 130 with the mounting bracket 140. A nut 137 may be provided to engage with a threaded portion of bolt 135 thus completing the connection. The nuts 137 may be tightened or loosened so as to provide just enough resistance to secure the assembly while simultaneously allowing for sliding engagement between the sliding mounting brackets 140 and the T-track 120.

FIG. 12 shows the sliding mounting brackets 140 after they have been attached to the T-track 120. At this point, the sliding mounting brackets 140 are adapted for connection to the table attachment 10A/10B/10C.

The sliding mounting brackets 140 may be attached to the table attachment 10A/10B/10C, for example, via mounting brackets 30, best shown in FIG. 1. For example, the table attachment 10A/10B/10C is placed against the processing device/worktable 200 such that the end caps (not shown) are touching the rip fence box beam 230, and such that the mounting brackets 30 and aligned with sliding mounting brackets 140. The center of each bolt in the nut and bolt connector 32 (shown in FIG. 1) is marked on each of the sliding mounting brackets 140. For example, a 21/64″ hole is bored into each mounting bracket 140. A 5/16″ bit may be used and then reamed up to 21/64″. Each hole should be countersunk such that the nut of the nut and bolt connector 32 settles into the hole and has little or no side to side movement. The nut and bolt connector 32 is tightened so as to secure the mounting brackets 30 to the sliding mounting brackets 140. The nut and bolt connector 32 is also adapted to provide vertical height adjustment of the table attachment 10A/10B/10C with respect to the processing device/worktable 200. In one embodiment, the ball rollers 24 should be set at a height so as to be about 1/32″ to 1/16″ higher than the top of the surface of the working surface 210 of the processing device/worktable 200. The adjustable leveling feet 12 may be adjusted vertically so as to provide a horizontally level working surface for the table attachment 10A/10B/10C.

As such, the table attachment 10A/10B/10C is secured to the processing device/worktable 200 and is ready to use. Due to the horizontal movement device 100, the table attachment 10A/10B/10C is provided in horizontal sliding engagement with respect to the processing device/worktable 200. As a result, sheet goods may be cut quickly and accurately. Also, due to the increased working area of the overall combined device, and due to the rollers 24 and cylindrical roller 28, it is easier to guide, move and cut sheet goods. The present inventors have observed that the present table attachment 10A/10B/10C is useful in preventing back injuries and strain to the user of the processing device/worktable 200, particularly as compared to use of the processing device/worktable 200 without the table attachment 10A/10B/10C.

The present table attachment 10A/10B/10C can be mounted and dismounted to the processing device/worktable 200 in a matter of minutes or even seconds. The table attachment 10A/10B/10C is multi positional along the rip fence using a T-track 120 and sliding mounting brackets 140. Multiple T-tracks 120 may be provided on multiple processing devices/worktables 200. As such, one table attachment 10A/10B/10C can be used interchangeably with multiple processing devices/worktables 200.

The table attachment 10B shown in FIG. 2 is the original and most popular embodiment of the present invention and is designed to permit one operator to handle bulky materials. The table attachment 10C shown in FIG. 3 is designed to easily install on a shaper or router table, and is particularly suited for shaping edges of materials. The present invention may also be used with contractor's saws. The present invention enlarges the feed area and the footprint of the saw, thus making the saw more stable.

While the present invention has been related in terms of the foregoing embodiments, those skilled in the art will recognize that the invention is not limited to the embodiments depicted. The present invention can be practiced with modification and alteration within the spirit and scope of the appended claims. Thus, the description is to be regarded as illustrative instead of restrictive on the present invention.

What is claimed is:

1. An feed attachment that facilitates processing of materials through a processing device, the feed attachment comprising:
a means for support;
a means for horizontal support and movement of the materials; and
a means for horizontal movement of the feed attachment with respect to the processing device.

2. The feed attachment of claim 1, wherein the means for horizontal support and movement of the materials comprises a plurality of ball rollers.

3. The feed attachment of claim 1, wherein the plurality of ball rollers are coplanar.

4. The feed attachment of claim 1, wherein the means for horizontal movement of the feed attachment with respect to the processing device comprises a track and an engagement section in sliding engagement with the track.

5. The feed attachment of claim 4, wherein the track comprises a groove,
wherein the groove has a T-shaped cross-section, and
wherein the engagement section has a T-shaped cross-section.

6. The feed attachment of claim 5, wherein the engagement section having a T-shaped cross-section comprises an L-shaped member, a washer, an intermediate member, a threaded bolt and a nut.

7. The feed attachment of claim 1 comprising a means for reducing friction during loading and unloading of the materials.

8. The feed attachment of claim 7, wherein the means for reducing friction during loading and unloading of the materials comprises a cylindrical roller.

9. The feed attachment of claim 1 comprising a means for vertical adjustment of the support frame.

10. The feed attachment of claim 1 comprising a means for folding the feed attachment into a flat shape.

11. A method of attaching an feed attachment for facilitating the processing of materials through a processing device, to the processing device, the feed attachment comprising a means for support, a means for horizontal support and movement of the materials, and a means for horizontal movement of the feed attachment with respect to the processing device, and the processing device comprising a table and a beam attached to the table with a plurality of bolts, the method comprising:
removing the plurality of bolts;
attaching support brackets to the beam using the plurality of bolts or longer bolts;
attaching the means for horizontal movement of the feed attachment with respect to the processing device to the support brackets; and
attaching the feed attachment to the means for horizontal movement of the feed attachment with respect to the processing device.

12. The method of claim 11, wherein the means for horizontal support and movement of the materials comprises a plurality of ball rollers.

13. The method of claim 11, wherein the plurality of ball rollers are coplanar.

14. The method of claim 11, wherein the means for horizontal movement of the feed attachment with respect to the processing device comprises a track and an engagement section in sliding engagement with the track.

15. The method of claim 14, wherein the track comprises a groove,
wherein the groove has a T-shaped cross-section, and
wherein the engagement section has a T-shaped cross-section.

16. The method of claim 15, wherein the engagement section having a T-shaped cross-section comprises an L-shaped member, a washer, an intermediate member, a threaded bolt and a nut.

17. The method of claim 11 comprising a means for reducing friction during loading and unloading of the materials.

18. The method of claim 17, wherein the means for reducing friction during loading and unloading of the materials comprises a cylindrical roller.

19. The method of claim 11 comprising a means for vertical adjustment of the support frame.

20. The method of claim 11 comprising a means for folding the feed attachment into a flat shape.
